(19) United States
(12) Patent Application Publication
(10) Pub. No.: US 2014/0085935 A1
(43) Pub. Date: Mar. 27, 2014

(54) POWER CONVERSION DEVICE

(71) Applicant: SAMSUNG SDI CO., LTD.,, Yongin-si (KR)

(72) Inventor: Seung-Yong LEE, Yongin-si (KR)

(73) Assignee: SAMSUNG SDI CO., LTD.,, Yongin-si, Gyeonggi-do (KR)

(21) Appl. No.: 13/833,731

(22) Filed: Mar. 15, 2013

(30) Foreign Application Priority Data
Sep. 27, 2012 (KR) 10-2012-0108177

(51) Int. Cl. H02M 1/14

(52) U.S. Cl. CPC H02M 1/143
USPC 363/13

(57) ABSTRACT

A power conversion device that includes first and second power conversion units; and a DC link unit positioned between the first and second power conversion units. In the power conversion device, the DC link unit includes a main capacitor and a dummy capacitor, which are selectively used. Accordingly, it is possible to prevent damage of a capacitor used in the DC link unit and to extend the lifespan of the capacitor.

### CLAIM PRIORITY

This application makes reference to, incorporates the same herein, and claims all benefits accruing under 35 U.S.C. §119 from an application earlier filed in the Korean Intellectual Property Office on 27 Sep. 2012 and there duly assigned Serial No. 10-2012-0108177.

### BACKGROUND OF THE INVENTION

1. Field of the Invention

An aspect of the present invention generally relates to a power conversion device.

2. Description of the Related Art

A capacitor is used for the purpose of voltage linking, voltage smoothing, etc. in a DC link unit of a power conversion device having an inverter for converting DC voltage into AC voltage, a DC-DC converter, etc.

An electrolytic capacitor having low-price, high-capacity and relatively fast charging/discharging characteristics is widely used as the DC link capacitor described above.

The above information disclosed in this Related Art section is only for enhancement of understanding of the background of the invention and therefore it may contain information that does not form the prior art that is already known to a person of ordinary skill in the art.

### SUMMARY OF THE INVENTION

Embodiments provide a power conversion device which can prevent damage of a capacitor used in a DC link unit and extend the lifespan of the capacitor.

According to an aspect of the present invention, there is provided a power conversion device including: first and second power conversion units; and a DC link unit positioned between the first and second power conversion units, wherein the DC link unit includes a main capacitor and a dummy capacitor, which are selectively used.

The DC link unit may use any one of the main capacitor and the dummy capacitor, selected corresponding to current output from the first power conversion unit.

The power conversion device may further include a current measurement unit that measures the amplitude of the ripple of the current output from the first power conversion unit to the DC link unit.

When the amplitude of the ripple of the current measured by the current measurement unit is no more than a predetermined reference value, the DC link unit may use the main capacitor.

When the amplitude of the ripple of the current measured by the current measurement unit is more than the predetermined reference value, the DC link unit may use the dummy capacitor rather than the main capacitor.

The power conversion device may further include first and second power lines coupled between the first and second power conversion units.

Each of the main capacitor and the dummy capacitor may be coupled between the first and second power lines.

The DC link unit may further include a first switch positioned between the main capacitor and the first or second power line.

The DC link unit may further include a second switch positioned between the dummy capacitor and the first or second power line.

The first and second switches may be alternately turned on.

When the amplitude of the ripple of the current output from the first power conversion unit to the DC link unit is no more than the predetermined reference value, the first switch may be turned on.

When the amplitude of the ripple of the current output from the first power conversion unit to the DC link unit is more than the predetermined reference value, the second switch may be turned on.

As described above, according to the present invention, it is possible to provide a power conversion device which can prevent damage of a capacitor used in a DC link unit and extend the lifespan of the capacitor.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIGS. 1 and 2 are block diagrams showing a power conversion device according to an embodiment of the present invention.

FIG. 3 is a block diagram showing a power storage system employing the power conversion device according to the embodiment of the present invention.

### DETAILED DESCRIPTION OF THE INVENTION

The example embodiments are described more fully hereinafter with reference to the accompanying drawings. The inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Often an increase in use of the electrolytic capacitor may create a serious problem that may be followed by an accident such as vaporization of an electrolyte, caused by the degradation and temperature rise of the electrolytic capacitor, etc.

Particularly, in which the electrolytic capacitor is continuously influenced by ripples of current, the lifespan and durability of the DC link capacitor may rapidly decrease, and this may cause problems in the power conversion device.

Hereinafter, a power conversion device according to an exemplary embodiment of the present invention will be described in detail with the accompanying drawings.

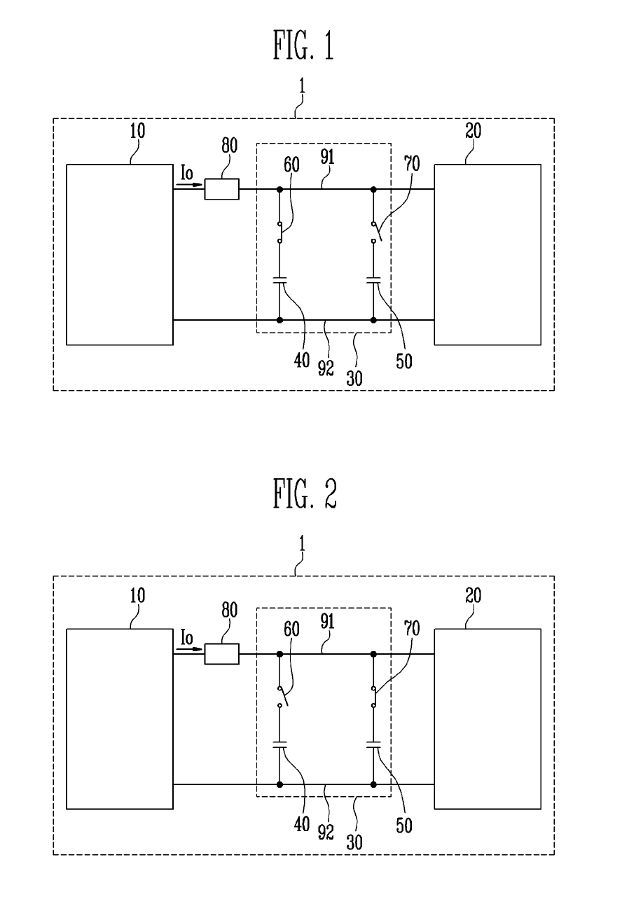

FIGS. 1 and 2 are block diagrams showing a power conversion device according to an embodiment of the present invention.

Particularly, the power conversion device 1 in a normal mode is shown in FIG. 1, and the power conversion device 1 in an abnormal mode is shown in FIG. 2.

Referring to FIGS. 1 and 2, the power conversion device 1 according to this embodiment includes a first power conversion unit 10, a second power conversion unit 20 and a DC link unit 30.

The first power conversion unit 10 may transmit, to the DC link unit 30, electric power transmitted from the outside thereof.

In this case, the first power conversion unit 10 converts the electric power transmitted from the outside so that an output voltage becomes a DC voltage.

For example, the first power conversion unit 10 may convert electric power generated in an external power generation system into a DC voltage and supply the converted DC voltage to the DC link unit 30.

The first power conversion unit 10 may be configured as a converter, rectifier circuit, etc. according to the kind of the power generation system.

For example, in a case where the power generation system generates DC power, the first power conversion unit 10 may be a converter for converting DC power into DC power.

On the contrary, in a case where the power generation system generates AC power, the first power conversion unit 10 may be a rectifier circuit for converting AC power into DC power.

The first power conversion unit 10 may be composed of a plurality converters or a plurality of rectifier circuits. The first power conversion unit 10 may be configured as a combination of converters and rectifier circuits.

The second power conversion unit 20 may receive a voltage output from the first power conversion unit 10, transmitted through the DC link unit 30. The second power conversion unit 20 may convert the transmitted voltage into a predetermined voltage and output the converted voltage.

For example, the second power conversion unit 20 may supply the converted voltage to an external load or power grid.

In this case, the second power conversion unit 20 may be configured as a converter for converting a DC voltage into a DC voltage having another voltage level, an inverter for converting a DC voltage into an AC voltage, etc.

The DC link unit 30 may be positioned between the first and second power conversion units 10 and 20 for the purpose of voltage linking, voltage smoothing and buffering of charging/discharging energy.

In this case, the DC link unit 30 according to this embodiment includes a main capacitor 40 and a dummy capacitor 50, which are selectively used.

Thus, in the DC link unit 30, the main capacitor 40 may be selectively used in the normal mode, and the dummy capacitor 50 may be selectively used in the abnormal mode in which a special situation occurs.

For example, in a case where it may be necessary to replace the main capacitor 40 due to its failure or expiration, the dummy capacitor 50 may be used rather than the main capacitor 40, so that the power conversion device 1 can be continuously used regardless of the failure of the main capacitor 40.

Then, if the replacement of the main capacitor 40 is completed, the use of the dummy capacitor 50 may be stopped, and the use of the main capacitor 40 can be started.

The main capacitor 40 and the dummy capacitor 50 are alternately used, so that the lifespan of the main capacitor 40 can also be extended.

Hereinafter, the configuration of the DC link unit 30 will be described in detail with reference to FIGS. 1 and 2.

First and second power lines 91 and 92 for transmitting electric power may be positioned between the first and second power conversion units 10 and 20.

In this case, the main capacitor 40 and the dummy capacitor 50 may be positioned between the first and second power lines 91 and 92 so as to be coupled to the first and second power lines 91 and 92.

To this end, the DC link unit 30 may further include a first switch 60 and a second switch 70.

The first switch 60 may be coupled between the main capacitor 40 and the first or second power line 91 or 92, and the second switch 70 may be coupled between the dummy capacitor 50 and the first or second power line 91 or 92.

Although it has been illustrated in FIGS. 1 and 2 that the first switch 60 may be positioned between the main capacitor 40 and the first power line 91, the first switch 60 may be positioned between the main capacitor 40 and the second power line 92.

Although it has been illustrated in FIGS. 1 and 2 that the second switch 70 may be positioned between the dummy capacitor 50 and the first power line 91, the second switch 70 may be positioned between the dummy capacitor 50 and the second power line 92.

That is, as shown in FIG. 1, the first switch 60 may be turned on and the second switch 70 may be turned off, so that the main capacitor 40 can be selectively used.

As shown in FIG. 2, the first switch 60 may be turned off and the second switch 70 may be turned on, so that the dummy capacitor 50 can be selectively used.

To alternately use the main capacitor 40 and the dummy capacitor 50, the first and second switches 60 and 70 may be alternately turned on.

Meanwhile, the ripple of current Io output from the first power conversion unit 10 has influence on the lifespan of the capacitor used in the DC link unit 30.

That is, if the main capacitor 40 is continuously used even when the amplitude of the ripple of the current Io, the lifespan and durability of the main capacitor 40 may be rapidly reduced.

To this end, the DC link unit 30 according to this embodiment may use any one of the main capacitor 40 and the dummy capacitor 50, selected corresponding to the current Io output from the first power conversion unit 10.

In this case, the power conversion device 1 according to this embodiment may further include a current measurement unit 80 for measuring the current Io output from the first power conversion unit 10 to the DC link unit 30.

For example, the current measurement unit 80 may measure the amplitude of the ripple of the current Io flowing through the first power line 91.

In this case, the amplitude of the ripple of the current Io may be obtained by measuring the peak value and/or valley value of the current Io.

In a case where the amplitude of the ripple of the current Io measured by the current measurement unit 80 is no more than a predetermined reference value, the DC link unit 30 decides the mode of the power conversion device 1 as a normal mode, so that it is possible to maintain the use of the main capacitor 40.

In a case where the amplitude of the ripple of the current Io measured by the current measurement unit 80 is more than the predetermined reference value, the DC link unit 30 decides the mode of the power conversion device 1 as an abnormal mode in which the main capacitor 40 may be damaged, so that it is possible to use the dummy capacitor 50 rather than the main capacitor 40.

To perform the operation described above, in a case where it is decided that the amplitude of the ripple of the current Io is no more than the predetermined reference value, the first switch 60 may be turned on and the second switch 70 may be turned off.

Accordingly, the main capacitor 40 may be electrically coupled between the first and second power lines 91 and 92.

In a case where it is decided that the amplitude of the ripple of the current Io is no less than the predetermined reference value, the first switch 60 may be turned off and the second switch 70 may be turned on.

Accordingly, the dummy capacitor 50 may be electrically coupled between the first and second power lines 91 and 92.

As a result, in a case where the amplitude of the ripple of the current Io output from the first power conversion unit 10 may be increased to a degree in which the amplitude of the ripple of the current Io has influence on the main capacitor 40, the dummy capacitor 50 may be used rather than the main capacity 50, so that it may be possible to prevent damage of the main capacitor 40. Thus, the lifespan of the main capacitor 40 can be extended.

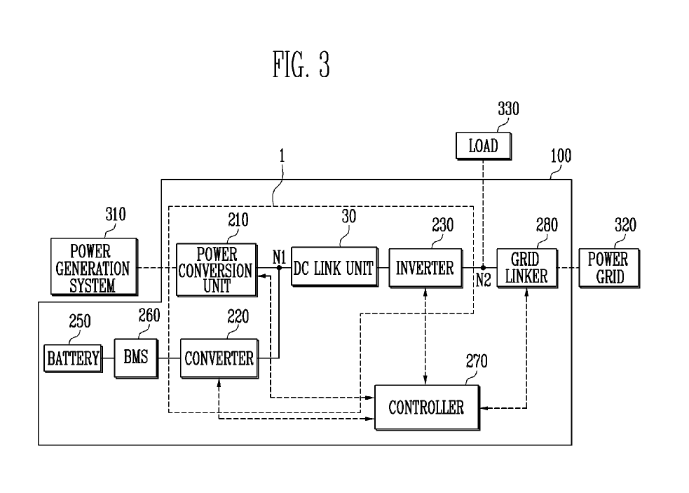

FIG. 3 is a block diagram showing a power storage system employing the power conversion device according to the embodiment of the present invention.

That is, the power storage system 100 shown in FIG. 3 includes the power conversion device 1 according to this embodiment.

In this case, a power conversion unit 210 and a converter 220, included in the power storage system 100 may correspond to the first power conversion unit 10 described above, and an inverter 230 may correspond to the second power conversion unit 20 described above.

Electric power generated in a power generation system 310 may be supplied to a load 330 or power grid 320 through the power storage system 100, or may be stored in the power storage system 100.

The power storage system 100 may receive electric power supplied from the power grid 320 and transmit the received electric power to the load. Alternatively, the power storage system 100 may store the electric power supplied from the power grid 320. The electric power stored in the power storage system 100 may be supplied to the load 330 or the power grid so as to be sold.

The power grid 320 may be an electrical grid including power stations, transformer substations and power transmission lines.

According to an embodiment, when the power grid 320 is in a normal situation, the power grid 320 supplies electric power to the power storage system 100 or the load 330, and transmits electric power supplied from the power storage system 100.

When the power grid 320 is in an abnormal situation, the supply of electric power from the power grid 320 to the power storage system 100 or the load 330 may be stopped. The supply of electric power from the power storage system 100 to the power grid 320 may be also stopped.

The load 330 receives electric power supplied from the power storage system 100 or receives commercial power supplied from the power grid 320.

For example, the load 330 may be a facility such as a house, building or factory, which consumes electric power supplied.

The power generation system 310 converts new or renewable energy into electrical energy and supplies the converted electrical energy to the power storage system 100.

According to an embodiment, the power generation system 310 may be a new and renewable energy generation system using renewable energy including sunlight, water, subterranean heat, rainwater, living organisms, etc.

For example, the power generation system 310 may be a solar power generation system that converts solar energy such as sun's heat and sunlight into electrical energy through solar cells.

In addition, the power generation system may be a wind power generation system that converts wind power into electrical energy, a geothermal generation system that converts subterranean heat into electrical energy, a hydroelectric power generation system, or an ocean power generation system.

The power generation system 310 may be a renewable energy generation system that generates electrical energy using fuel cells or generates electrical energy using hydrogen, coal liquefied gas or heavy residual oil gas.

It will be apparent that the power generation system 310 may be implemented in various manners in addition to the aforementioned embodiments.

The power storage system 100 may store electric power generated in the power generation system 310 and transmit the generated power to the power grid 320.

The power storage system 100 may transmit electric power stored in a battery 250 to the power grid 320, or may store electric power supplied from the power grid 320 in the battery 250.

The power storage system 100 may supply electric power to the load by performing an uninterruptible power supply (UPS) operation in an abnormal situation, e.g., when the interruption of electric power occurs in the power grid. The power storage system 100 may supply, to the load 330, electric power generated in the power generation system 310 or electric power stored in the battery 250 even in a normal state of the power grid 320.

The power storage system 100 includes the power conversion unit 210, the DC link unit 30, the inverter 230, the battery 250, a battery management system (hereinafter, referred to as a ‘BMS’) 260, the converter 220, a grid linker 280 and a controller 270.

The power conversion unit 210 may be coupled between the power generation system 310 and a first node N1. The power conversion unit 210 converts electric power generated in the power generation system 310 into a DC voltage of the first node N1.

The operation of the power conversion unit 210 may be changed depending on the electric power generated in the power generation system 310.

For example, in a case where the power generation system 310 generates an AC voltage, the power conversion unit 210 converts the AC voltage into the DC voltage of the first node N1.

In a case where the power generation system 310 generates a DC voltage, the power conversion unit 210 rises or drops the DC voltage into the DC voltage of the first node N1.

For example, in a case where the power generation system 310 is a solar power generation system, the power conversion unit 210 may be a maximum power point tracking (MPPT) converter that detects a maximum power point depending on a change in solar radiation caused by sunlight or a change in temperature caused by sun's heat and generates electric power.

In addition, various kinds of converters or rectifiers may be used as the power conversion unit 210.

The inverter 230 may be coupled between the first node N1 and a second node N2 to which the load 220 and/or the grid linker 280. The inverter 230 performs DC-AC inversion or AC-DC inversion.

The converter 220 converts a DC voltage output from the power grid 320 and converted by the inverter 230 or a DC voltage output from the power generation system 310 via the power conversion unit 210 and supplies the converted DC voltage to the battery 250.

The converter 220 rises or drops a DC voltage output from the battery 250 via the BMS 260 and transmits the DC voltage to the load 330 or the power grid 320.

For example, in a case where the voltage level of the first node N1 is 380V and the voltage level required in the BMS 260 is 100V, the converter 220 drops the DC voltage of 380V into the DC voltage of 100V so as to charge the battery 250 with the DC voltage of 100V, and rises the DC voltage of 100V to the DC voltage of 380V so as to supply the DC voltage of 380V to the load 330 or the power grid 320.

According to an embodiment, the converter 220 may include a buck mode operation switch, a synchronization rectification switch and an inductor acting as a filter. In addition, various types of converters may be used as the converter 220.

The DC link unit 30 may be coupled between the power conversion unit 210 or converter 220 and the inverter 230.

The DC link unit 30 performs a function of stabilizing the DC voltage level of the first node N1 to a DC link voltage level.

For example, the voltage level of the first node N1 may be unstable due to a rapid change in electric power generated in the power generation system or an instantaneous voltage drop occurring in the power grid 320.

However, the voltage of the first node N1 is necessarily maintained constant to perform stable operations of the inverter 230 and the converter 220. The DC link unit 30 performs such a function.

The DC link unit 30 may include the main capacitor 40 and the dummy capacitor 50 as described above. The detailed descriptions of the main capacitor 40 and the dummy capacitor 50 will be omitted to avoid redundancy.

The grid linker 280 may be coupled between the power grid 320 and the inverter 230. In a case where an abnormal situation occurs in the power grid 320, the grid linker 280 cuts off the linkage between the power storage system 100 and the power grid 320 under the control of the controller 270.

The grid linker 280 may be implemented as a switching element, and may be a bipolar junction transistor (BJT), field effect transistor (FET), etc.

Although not shown in this figure, a switch may be further coupled between the inverter 230 and the load 330. The switch may be coupled in series to the grid linker 280, and cuts off electric power flowing in the load 330 under the control of the controller 270. The switch may be implemented as a BJT, FET, etc.

The battery 250 receives electric power generated in the power generation system 310 or electric power of the power grid 320 and stores the received electric power. The battery 250 supplies electric power stored in the load 330 or the power grid 320.

The battery 250 may be composed of at least one battery cell, and each battery cell may include a plurality of bare cells.

The battery 250 may be implemented as various kinds of battery cells. For example, the battery 250 may be a nickel-cadmium battery, lead storage battery, nickel metal hydride battery (NiMH), lithium ion battery, lithium polymer battery, etc.

The number of batteries 250 may be determined according to power capacity and design condition required in the power storage system 100.

For example, in a case where the power consumed in the load 330 is large, the battery 250 may be provided with a plurality of batteries. In a case where the power consumed in the load 330 is small, the battery 250 may be provided with only one battery.

The BMS 260 may be coupled to the battery 250, and controls charging and discharging operations of the battery 250 under the control of the controller 270.

The BMS 260 may perform an overcharging protection function, an overdischarging protection function, an overcurrent protection function, an overheating protection function, a cell balancing function, etc. so as to protect the battery 250.

To this end, the BMS 260 may monitor voltage, current, temperature, remaining power amount, lifespan and charging state of the battery 250 and transmit relative information to the controller 270.

Although the BMS 260 may be provided separately from the battery 250 in this embodiment, it will be apparent that the BMS 260 and the battery 250 may be integrated as a battery pack.

The controller 270 monitors states of the power generation system 310, the power grid 320, the battery 250 and the load 330, and controls the power conversion unit 210, the inverter 230, the BMS 260, the converter 220 and the grid linker 280 according to the monitored result.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A power conversion device, comprising:
a first power conversion unit;
a second power conversion unit; and
a DC link unit positioned between the first and second power conversion units, said DC link unit includes a main capacitor and a dummy capacitor, which are selectively used.

2. The power conversion device according to claim 1, wherein the DC link unit uses any one of the main capacitor and the dummy capacitor, selected corresponding to current output from the first power conversion unit.

3. The power conversion device according to claim 1, further comprising:
a current measurement unit that measures the amplitude of a ripple of the current output from the first power conversion unit to the DC link unit.

4. The power conversion device according to claim 3, wherein, when the amplitude of the ripple of the current measured by the current measurement unit is no more than a predetermined reference value, the DC link unit uses the main capacitor.

5. The power conversion device according to claim 4, wherein, when the amplitude of the ripple of the current measured by the current measurement unit is more than the predetermined reference value, the DC link unit uses the dummy capacitor rather than the main capacitor.

6. The power conversion device according to claim 1, further comprising first and second power lines coupled between the first and second power conversion units.

7. The power conversion device according to claim 6, wherein each of the main capacitor and the dummy capacitor is coupled between the first and second power lines.

8. The power conversion device according to claim 7, wherein the DC link unit further includes a first switch positioned between the main capacitor and the first or second power line.

9. The power conversion device according to claim 8, wherein the DC link unit further includes a second switch positioned between the dummy capacitor and the first or second power line.

10. The power conversion device according to claim 9, wherein the first and second switches are alternately turned on.

11. The power conversion device according to claim 10, wherein, when the amplitude of the ripple of the current output from the first power conversion unit to the DC link unit is no more than the predetermined reference value, the first switch is turned on.

12. The power conversion device according to claim 11, wherein, when the amplitude of the ripple of the current output from the first power conversion unit to the DC link unit is more than the predetermined reference value, the second switch is turned on.

13. A power conversion device, comprising:
a first power conversion unit to receive electric power from a power generation system;
a second power conversion unit to transmit electric power to an external load or a power grid;
a DC link unit having a main capacitor and a dummy capacitor positioned between and connected electrically to the first and second power conversion units, said DC link unit receives current from the first power conversion unit and transmits current to the second power conversion unit; and
a current measurement unit that measures an amplitude of a ripple of the current output from the first power conversion unit to the DC link unit,
wherein, when the amplitude of the ripple of the current measured by the current measurement unit is equal to or less than a predetermined reference value, the DC link unit switches to the exclusive use of the main capacitor rather than the dummy capacitor, and
wherein, when the amplitude of the ripple of the current measured by the current measurement unit is more than a predetermined reference value, the DC link unit switches to the exclusive use of the dummy capacitor rather than the main capacitor.

14. The power conversion device recited in claim 13, further comprising:
a first power line electrically connected between the first and second power conversion units; and
a second power line electrically connected between the first and second power conversion units.

15. The power conversion device recited in claim 14, wherein each of the main capacitor and the dummy capacitor is coupled between the first and second power lines.

16. The power conversion device recited in claim 15, wherein the DC link unit further comprises:
a first switch electrically connected between the main capacitor and the first or second power line.

17. The power conversion device recited in claim 16, wherein the DC link unit further comprises:
a second switch electrically connected between the dummy capacitor and the first or second power line.

18. The power conversion device recited in claim 17, wherein, when the amplitude of the ripple of the current output from the first power conversion unit to the DC link unit is no more than the predetermined reference value, the first switch is turned on and the second switch is turned off.

19. The power conversion device recited in claim 18, wherein, when the amplitude of the ripple of the current output from the first power conversion unit to the DC link unit is more than the predetermined reference value, the second switch is turned on and the first switch is turned off.

20. The power conversion device recited in claim 19, wherein the power generation system is a renewable energy generation system using renewable energy including sunlight, water, subterranean heat, rainwater, or living organisms, and
wherein the external load is a facility including a house, building or factory, which consumes electric power.
